(19) United States
(12) Patent Application Publication
(10) Pub. No.: US 2026/0247357 A1
(43) Pub. Date: Aug. 20, 2026

(54) METHOD AND APPARATUS FOR CANCELING TIME DIVISION INTERFERENCE

(71) Applicant: Beijing Xiaomi Mobile Software Co., Ltd., Beijing (CN)

(72) Inventor: Yumin WU, Beijing (CN)

(73) Assignee: Beijing Xiaomi Mobile Software Co., Ltd., Beijing (CN)

(21) Appl. No.: 18/852,141

(22) PCT Filed: Mar. 31, 2022
(86) PCT No.: PCT/CN2022/084659

§ 371 Date: Sep. 27, 2024

(51) Int. Cl. H04W 72/0446; H04L 5/14

(52) U.S. Cl. CPC H04W 72/0446; H04L 5/14

(57) ABSTRACT

A method for canceling time division interference, includes: sending to a network device expected transmission time information, and at least one of signal transmission feature information or frequency information corresponding to the expected transmission time information.

### CROSS-REFERENCE

The present application is a U.S. National Stage of International Application No. PCT/CN2022/084659, filed on Mar. 31, 2022, the contents of all of which are incorporated herein by reference in their entireties for all purposes.

### BACKGROUND OF THE INVENTION

Due to the requirements of different networks and businesses, the same terminal device may be equipped with a plurality of different wireless transceivers, such as transceivers corresponding to radio access technologies such as long term evolution (LTE), 5th generation mobile communication technology (5G), wireless fidelity (WIFI), Bluetooth, and a global navigation satellite system (GNSS).

### SUMMARY OF THE INVENTION

The disclosure relates to the technical field of communications, in particular to a method for canceling time division interference and an apparatus.

Examples of the disclosure provide a method for canceling time division interference and an apparatus.

In a first aspect, an example of the disclosure provides a method for canceling time division interference, and the method is performed by a terminal device and includes: sending to a network device expected transmission time information, and at least one of signal transmission feature information or frequency information corresponding to the expected transmission time information, where the transmission time information is at least one of the following: sending time information or receiving time information.

In a second aspect, an example of the disclosure provides a method for canceling time division interference, and the method is performed by a network device and includes: receiving expected transmission time information, and at least one of signal transmission feature information or frequency information corresponding to the expected transmission time information sent by a terminal device, where the transmission time information is at least one of the following: sending time information or receiving time information.

In a third aspect, an example of the disclosure provides a communication apparatus, the communication apparatus includes one or more processors and one or more memories, and a computer program is stored in the one or more memories; and the one or more processors execute the computer program stored in the one or more memories to cause the communication apparatus to perform: sending to a network device expected transmission time information, and at least one of signal transmission feature information or frequency information corresponding to the expected transmission time information, where the transmission time information is at least one of the following: sending time information or receiving time information.

### BRIEF DESCRIPTION OF DRAWINGS

In order to describe the technical solution in examples of the disclosure or the background more clearly, the accompanying drawings that need to be used in the examples of the disclosure or the background will be described below.

FIG. 1 is a schematic architectural diagram of a communication system provided by an example of the disclosure.

FIG. 2 is a schematic flow diagram of a method for canceling time division interference provided by an example of the disclosure.

FIG. 3 is a schematic flow diagram of a method for canceling time division interference provided by an example of the disclosure.

FIG. 4 is a schematic flow diagram of a method for canceling time division interference provided by an example of the disclosure.

FIG. 5 is a schematic flow diagram of a method for canceling time division interference provided by an example of the disclosure.

FIG. 6 is a schematic flow diagram of a method for canceling time division interference provided by an example of the disclosure.

FIG. 7 is a schematic flow diagram of a method for canceling time division interference provided by an example of the disclosure.

FIG. 8 is a schematic flow diagram of a method for canceling time division interference provided by an example of the disclosure.

FIG. 9 is a schematic flow diagram of a method for canceling time division interference provided by an example of the disclosure.

FIG. 10 is a schematic structural diagram of a communication apparatus provided by an example of the disclosure.

FIG. 11 is a schematic structural diagram of another communication apparatus provided by an example of the disclosure.

FIG. 12 is a schematic structural diagram of a chip provided by an example of the disclosure.

### DETAILED DESCRIPTION OF THE INVENTION

Due to the requirements of different networks and businesses, the same terminal device may be equipped with a plurality of different wireless transceivers, such as transceivers corresponding to radio access technologies such as long term evolution (LTE), 5th generation mobile communication technology (5G), wireless fidelity (WIFI), Bluetooth, and a global navigation satellite system (GNSS). At parts of adjacent frequencies or harmonic frequencies, a receiver of the terminal device may experience interference from transmitters corresponding to the same or different radio access technologies (RATs).

For the convenience of understanding, terms involved in the disclosure are introduced first.

### 1. Subcarrier Spacing (SCS)

A carrier is a frequency domain resource concept in a communication system, and a subcarrier may be considered as a small segment of frequency domain resources that can be modulated independently. One sub-channel has one or more subcarriers, for example, in a bandwidth of 100 MHz, assuming that 15 KHz is one subcarrier, then this sub-channel may contain a plurality of subcarriers.

### 2. Cyclic Prefix (CP)

A cyclic prefix is formed by duplicating a signal at the tail of an orthogonal frequency division multiplexing (OFDM) symbol to the head. A CP includes two types, namely a normal cyclic prefix and an extended cyclic prefix respectively. A length of the normal cyclic prefix is 4.7 μs, and a length of the extended cyclic prefix is 16.67 μs. The cyclic prefix may be associated with other multipath component information to obtain complete information. Furthermore, the cyclic prefix may realize a pre-estimation of time and frequency synchronization.

To better understand a method for canceling time division interference disclosed by an example of the disclosure, a communication system to which the example of the disclosure is applied is described first below.

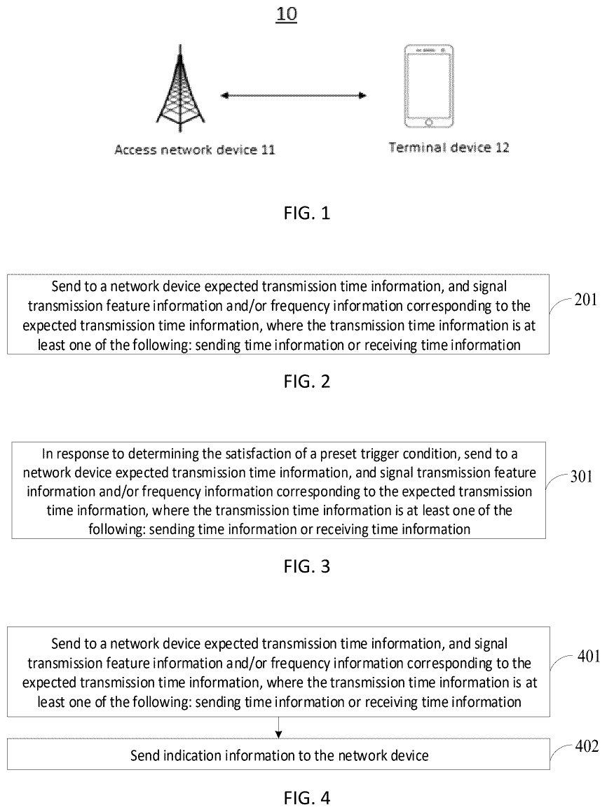

Referring to FIG. 1, FIG. 1 is a schematic architectural diagram of a communication system provided by an example of the disclosure. The communication system may include but is not limited to one network device and one terminal device, the number and form of the devices shown in FIG. 1 are for example merely and do not constitute a limitation on the example of the disclosure, and in practical applications, it may include two or more network devices and two or more terminal devices. The communication system 10 shown in FIG. 1, for example, includes one access network device 11 and one terminal device 12.

It should be noted that the technical solution of the example of the disclosure may be applied to various communication systems, such as: a long term evolution (LTE) system, a 5th generation (5G) mobile communication system, a 5G new radio (NR) system or other novel mobile communication systems in the future.

The network device 11 in the example of the disclosure is an entity for transmitting or receiving signals at a network side. For example, the network device 11 may be an evolved NodeB (eNB), a transmission reception point (TRP), a next generation NodeB (gNB) in an NR system, base stations in other mobile communication systems in the future or access nodes in a wireless fidelity (WiFi) system, etc. Specific techniques and specific device forms adopted by the network device are not limited in the example of the disclosure. The network device provided by the example of the disclosure may be composed of a central unit (CU) and a distributed unit (DU), where the CU may also be referred to as a control unit, protocol layers of the network device (e.g., base station) may be split using the CU-DU structure, functions of part of the protocol layers are controlled in a centralized mode in the CU, functions of the remaining part or all of the protocol layers are distributed in the DU, and the DU is controlled by the CU in a centralized mode.

The terminal device 12 in the example of the disclosure is an entity for receiving or transmitting signals at a user side, such as a mobile phone. The terminal device 12 may also be referred to as a terminal, user equipment (UE), a mobile station (MS), a mobile terminal (MT), etc. The terminal device may be a car with a communication function, a smart car, a mobile phone, a wearable device, a pad, a computer with a wireless receiving and sending function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home and the like. Specific techniques and specific device forms adopted by the terminal device are not limited in the example of the disclosure.

It is understandable that, the communication system 10 described in the example of the disclosure is to illustrate the technical solution of the example of the disclosure more clearly, and does not constitute a limitation on the technical solution provided by the example of the disclosure. It is known to those ordinarily skilled in the art that with the evolution of a system architecture and the appearance of new business scenarios, the technical solution provided by the example of the disclosure is also suitable for similar technical problems.

Typically, the terminal device 12 may send transmission time information expected by itself to the network device 11 in a case of interference, and thus the network device may perform transmission at a transmission slot or symbol position expected by the terminal device, so that data transmission failure caused by interference is avoided, which is beneficial to improving the communication quality. However, in a 5G system, multiple types of subcarrier spacing may be supported, the quantity of symbols per slot, the quantity of slots per frame and the quantity of slots per sub-frame corresponding to each type of subcarrier spacing may be different, and due to the change of the quantity of slots, a transmission slot or symbol position expected by the terminal device determined according to the expected transmission time information sent by the terminal device has errors, resulting in data transmission failure. In the disclosure, the terminal device may report the transmission time information expected by itself, and signal transmission feature information and/or frequency information corresponding to the expected transmission time information to the network device, and thus the network device may accurately determine a transmission slot or symbol position expected by the terminal device and perform transmission at the transmission slot or symbol position expected by the terminal device, so that data transmission failure caused by time division interference is avoided, which is beneficial to improving the communication quality. A method for canceling time division interference and an apparatus of the method provided by the disclosure are introduced in detail in combination with the accompanying drawings.

Referring to FIG. 2, FIG. 2 is a schematic flow diagram of a method for canceling time division interference provided by an example of the disclosure. The method is performed by a terminal device. As shown in FIG. 2, the method may include but is not limited to step 201.

In step 201, expected transmission time information, and signal transmission feature information and/or frequency information corresponding to the expected transmission time information are sent to a network device, where the transmission time information is at least one of the following: sending time information or receiving time information.

An expected transmission time information may include an expected transmission time position. The expected transmission time position may include a slot or symbol position where transmission is expected and the like, which is not limited in the disclosure.

Alternatively, the signal transmission feature information corresponding to the expected transmission time information may include at least one of the following: a subcarrier spacing corresponding to the expected transmission time position, such as 15 kHz; or a CP type corresponding to the expected transmission time position, such as a normal CP type and an extended CP type.

Alternatively, the frequency information may be at least one of the following: a cell type indication, a cell group indication, a cell identifier, a bandwidth part (BWP) identifier, a frequency point identifier, a bandwidth, starting frequency information or ending frequency information.

The cell type indication is used to indicate the type of cell. For example, the type of cell indicated by the cell type indication may include: a primary cell (PCell), a secondary cell (SCell), a primary secondary cell (PSCell) or a special cell (SpCell).

The cell group indication is used to indicate the type of cell group. The cell group indicated by the cell group indication may include any one of the following: a master cell group (MCG) or a secondary cell group (SCG).

The cell identifier may be a physical cell identifier (PCI) or a cell global identifier (CGI), etc.

The BWP identifier may be any information which may uniquely determine a BWP, such as a BWP number.

The frequency point identifier may be information which may uniquely determine a frequency point, such as absolute radio frequency channel number (ARFCN) of a center frequency point.

The starting frequency information may be information which may uniquely determine a starting frequency, such as ARFCN of a starting frequency point or a starting physical resource block (PRB) number. The ending frequency information may be information which may uniquely determine an ending frequency, such as ARFCN of an ending frequency point or an ending PRB number.

In a 5G system, in order to increase a frequency band utilization rate, the network device may configure different SCSs for different cells or BWPs, and thus bandwidths are allocated according to actual communication demands, and bandwidth waste is avoided. Furthermore, different SCSs and CPs may correspond to different time domain resource allocation granularities, for example, subcarrier spacings of 15 kHz and 3015 kHz correspond to different quantities of slots per frame and different quantities of slots per sub-frame. A normal CP and an extended CP correspond to different quantities of symbols per slot and different quantities of slots per sub-frame. Meanwhile, in the 5G system, uplink and downlink sub-frame configurations may further be performed flexibly according to actual demands, that is, for all slots within a specified cycle, uplink or downlink transmission may be specified to be performed on a specific slot. For example, for 10 slots within a 10 ms cycle, the first 3 slots are downlink slots, the last 3 slots are uplink slots, and the middle 4 slots are flexible slots. Thus, in a more flexible 5G system, in a case that an uplink and downlink slot ratio and a subcarrier spacing are changed continuously, while the expected transmission time information is sent to the network device by the terminal device, it is needed to guarantee that the terminal device and the network device have the consistent understanding on the expected transmission time information reported by the terminal device, then the network device may accurately determine the transmission time position expected by the terminal device and perform data transmission at this transmission time position. Thus, the phenomenon of data transmission failure can be avoided, which is beneficial to improving the communication quality.

In the disclosure, while the expected transmission time information is sent to the network device by the terminal device, the signal transmission feature information and/or frequency information corresponding to the expected transmission time information may be sent to the network device. Then the network device may determine a corresponding time domain resource allocation granularity according to the signal transmission feature information and/or frequency information corresponding to the expected transmission time information. Afterwards, the network device may determine the transmission time position expected by the terminal device. Thus, it is guaranteed that the understanding on the expected transmission time information is consistent with the terminal device, and it is further guaranteed that data transmission can be performed at the transmission time position expected by the terminal device.

In the disclosure, the expected transmission time information, and the signal transmission feature information and/or frequency information corresponding to the expected transmission time information are sent to the network device by the terminal device. Thus, the network device may accurately determine, according to the signal transmission feature information and/or frequency information corresponding to the expected transmission time information, a transmission time position expected by the terminal device and perform data transmission at the transmission time position, so that the phenomenon of data transmission failure caused by time division interference is avoided, and the communication quality is improved.

Referring to FIG. 3, FIG. 3 is a schematic flow diagram of a method for canceling time division interference provided by an example of the disclosure. The method is performed by a terminal device. As shown in FIG. 3, the method may include but is not limited to step 301.

In step 301, in response to determining the satisfaction of a preset trigger condition, expected transmission time information, and signal transmission feature information and/or frequency information corresponding to the expected transmission time information are sent to a network device, where the transmission time information is at least one of the following: sending time information or receiving time information.

The preset trigger condition may be any one of the following: occurring a self-interference problem to the terminal device, having an energy saving demand of the terminal device, or having a capability using limitation demand of the terminal device.

For specific explanation of the signal transmission feature information and/or frequency information corresponding to the expected transmission time information, see the detailed explanation of any example of the disclosure, which is not repeated here.

In the disclosure, the terminal device may be equipped with a plurality of different wireless transceivers, and the wireless transceivers may have a self-interference phenomenon, for example, a 5G receiver of the terminal device is interfered by signals sent by WiFi or a Bluetooth apparatus in the terminal device. At the moment, to guarantee the communication quality, the expected transmission time information may be sent to the network device, and thus the network device may perform data transmission at expected transmission time, so that the interference problem is avoided, and the communication quality is improved.

Alternatively, in order to avoid the consumption of electricity, at the moment, the terminal device may send the expected transmission time information to the network device to indicate that it is not expected to send uplink signals at a specific slot, and thus the network device may perform data transmission at expected transmission time, so that resource waste caused by continuous sending of signals of the terminal device is avoided.

Alternatively, when the terminal device has a capability using limitation demand, for example, the terminal device has 2 subscriber identity module (SIM) cards, such as SIM card 1 and SIM card 2. When the receiving capability of the SIM card 2 is limited by the using of the SIM card 1, the terminal device may send the expected transmission time information to the network device to indicate that the terminal device does not use resources related to the SIM card 2 for signal sending at a specific slot and may use resources related to the SIM card 1 for signal sending.

In the disclosure, an expected transmission time position may include at least one of the following: a slot or symbol position, a slot or symbol position corresponding to a frequency division duplexing (FDD) configuration, a slot or symbol position corresponding to a frequency division duplexing (FDD) frequency band, a slot or symbol position corresponding to an uplink and downlink slot ratio configuration specified in a time division duplexing (TDD) configuration, or a slot or symbol position corresponding to an uplink and downlink slot ratio configuration specified in a time division duplexing (TDD) frequency band.

It is understandable that the slot or symbol position in the expected transmission time position is where transmission is expected. In the disclosure, an expected transmission time position may include at least one of the following: a slot or symbol position where transmission is expected, a slot or symbol position where transmission is expected corresponding to a frequency division duplexing (FDD) configuration, a slot or symbol position where transmission is expected corresponding to a frequency division duplexing (FDD) frequency band, a slot or symbol position where transmission is expected corresponding to an uplink and downlink slot ratio configuration specified in a time division duplexing (TDD) configuration, or a slot or symbol position where transmission is expected corresponding to an uplink and downlink slot ratio configuration specified in a time division duplexing (TDD) frequency band.

Furthermore, the uplink and downlink slot ratio configuration includes at least one of the following: a configuration cycle of an uplink and downlink slot ratio, the quantity of downlink slots in the uplink and downlink slot ratio, the quantity of downlink symbols in the uplink and downlink slot ratio, the quantity of uplink slots in the uplink and downlink slot ratio, the quantity of uplink symbols in the uplink and downlink slot ratio, the quantity of flexible slots in the uplink and downlink slot ratio, or the quantity of flexible symbols in the uplink and downlink slot ratio.

In the disclosure, a slot or symbol position where transmission is expected may be indicated through a bit map. For example, a subcarrier spacing corresponds to 20 slots or symbols, then a bit map containing 20 bits may be used to indicate the slot or symbol position where transmission is expected, where each bit corresponds to 1 uplink (i.e., sending) or downlink (i.e., receiving) slot or symbol, when a value “0” of a bit represents that data transmission at the slot or symbol position is not expected, a value “1” of a bit represents that data transmission at the slot or symbol position is expected, and when a bit is empty, it represents that the slot or symbol position is a flexible slot or symbol.

In the disclosure, the slot or symbol position where transmission is expected corresponding to the frequency division duplexing (FDD) configuration or frequency band may be indicated through a bit map, for example, as for an FDD uplink sending frequency, a subcarrier spacing corresponds to 20 slots or symbols, then a bit map containing 20 bits may be used to indicate a slot or symbol position where sending is expected, where each bit corresponds to 1 uplink (i.e., sending) slot or symbol, and when a value “0” of a bit represents that data sending at the slot or symbol position is not expected, a value “1” of a bit represents that data sending at the slot or symbol position is expected. As for an FDD downlink receiving frequency, a subcarrier spacing corresponds to 20 slots or symbols, then a bit map containing 20 bits may be used to indicate a slot or symbol position where receiving is expected, where each bit corresponds to 1 downlink (i.e., receiving) slot or symbol, when a value “0” of a bit represents that data receiving at the slot or symbol position is not expected, a value “1” of a bit represents that data receiving at the slot or symbol position is expected, and when a bit is empty, it represents that the slot or symbol position is a flexible slot or symbol.

In the disclosure, the slot or symbol position where transmission is expected corresponding to the uplink and downlink slot ratio configuration specified in the time division duplexing (TDD) configuration or frequency band may also be indicated through a bit map. When the uplink and downlink slot ratio configuration includes the configuration cycle of the uplink and downlink slot ratio, the uplink and downlink slot ratio may be periodically repeated, for example, the uplink and downlink slot ratio is repeated with 10 ms as a cycle.

When the uplink and downlink slot ratio configuration includes the quantity of the downlink slots in the uplink and downlink slot ratio, for example, the first 2 slots in 10 slots are downlink slots, slots where transmission is expected corresponding to the downlink slots may be identified using bits with the quantity being the same as the quantity of the downlink slots, when a value “0” of a bit represents that data receiving at the slot position is not expected, a value “1” of a bit represents that data receiving at the slot position is expected, and when a bit is empty, it represents that the slot or symbol position is a flexible slot or symbol.

When the uplink and downlink slot ratio configuration includes the quantity of the downlink symbols in the uplink and downlink slot ratio, for example, the first 2 symbols in 10 symbols are downlink symbols, symbols where transmission is expected corresponding to the downlink symbols may be identified using bits with the quantity being the same as the quantity of the downlink symbols, when a value “0” of a bit represents that data receiving at the symbol position is not expected, a value “1” of a bit represents that data receiving at the symbol position is expected, and when a bit is empty, it represents that the slot or symbol position is a flexible slot or symbol.

When the uplink and downlink slot ratio configuration includes the quantity of the uplink slots in the uplink and downlink slot ratio, for example, the first 2 slots in 10 slots are uplink slots, slots where transmission is expected corresponding to the uplink slots may be identified using bits with the quantity being the same as the quantity of the uplink slots, when a value “0” of a bit represents that data sending at the slot position is not expected, a value “1” of a bit represents that data sending at the slot position is expected, and when a bit is empty, it represents that the slot or symbol position is a flexible slot or symbol.

When the uplink and downlink slot ratio configuration includes the quantity of the uplink symbols in the uplink and downlink slot ratio, for example, the first 2 symbols in 10 symbols are uplink symbols, symbols where transmission is expected corresponding to the uplink symbols may be identified using bits with the quantity being the same as the quantity of the uplink symbols, when a value “0” of a bit represents that data sending at the symbol position is not expected, a value “1” of a bit represents that data sending at the symbol position is expected, and when a bit is empty, it represents that the slot or symbol position is a flexible slot or symbol.

When the uplink and downlink slot ratio configuration includes the quantity of the flexible slots in the uplink and downlink slot ratio, for example, the first 2 slots in 10 slots are flexible slots, slots where transmission is expected corresponding to the flexible slots may be identified using bits with the quantity being the same as the quantity of the flexible slots, and when a value “0” of a bit represents that data sending or receiving at the slot position is not expected, a value “1” of a bit represents that data sending or receiving at the slot position is expected.

When the uplink and downlink slot ratio configuration includes the quantity of the flexible symbols in the uplink and downlink slot ratio, for example, the first 2 symbols in 10 symbols are flexible symbols, symbols where transmission is expected corresponding to the flexible symbols may be identified using bits with the quantity being the same as the quantity of the flexible symbols, and when a value “0” of a bit represents that data sending or receiving at the symbol position is not expected, a value “1” of a bit represents that data sending or receiving at the symbol position is expected.

Alternatively, the expected transmission time information includes a time position where transmission is prohibited. Alternatively, the quantity of time positions where transmission is prohibited in the expected transmission time information is less than or equal to the quantity configured by the network device; or, the quantity of time positions where transmission is prohibited in the expected transmission time information is less than or equal to the quantity agreed in a protocol. The quantity configured by the network device or the quantity agreed in the protocol may be the quantity of uplink hybrid automatic repeat request (HARQ) processes supported by the terminal device or the quantity of downlink HARQ processes supported by the terminal device.

In the disclosure, in a case that the preset trigger condition is satisfied, the expected transmission time information, and the signal transmission feature information and/or frequency information corresponding to the expected transmission time information may be sent to the network device by the terminal device. Thus, the network device may accurately determine, according to the signal transmission feature information and/or frequency information corresponding to the expected transmission time information, the transmission time position expected by the terminal device and perform data transmission at the transmission time position, so that the phenomenon of data transmission failure caused by time division interference is avoided, and the communication quality is improved.

Referring to FIG. 4, FIG. 4 is a schematic flow diagram of a method for canceling time division interference provided by an example of the disclosure. The method is performed by a terminal device. As shown in FIG. 4, the method may include but is not limited to steps 401 and 402.

In step 401, expected transmission time information, and signal transmission feature information and/or frequency information corresponding to the expected transmission time information are sent to a network device, where the transmission time information is at least one of the following: sending time information or receiving time information.

In the disclosure, see the detailed description of any example of the disclosure for a specific implementation process of step 401, which is not repeated here.

In step 402, indication information is sent to the network device.

The indication information may indicate at least one of the following: whether to expect to send at flexible slots or symbols in a time division duplexing (TDD) configuration or frequency band as uplink slots, whether to expect to receive at the flexible slots or symbols in the time division duplexing (TDD) configuration or frequency band as downlink slots, or whether to expect to use the flexible slots or symbols in the time division duplexing (TDD) configuration or frequency band.

In the disclosure, the terminal device may further send indication information to the network device to indicate that the flexible slots or symbols in the time division duplexing (TDD) configuration or frequency band are expected to be uplink slots or symbols, or downlink slots or symbols, or flexible slots or symbols. When the indication information indicates that it is expected to send the flexible slots or symbols in the time division duplexing (TDD) configuration or frequency band as the uplink slots, the network device may determine that the terminal device sends data at the slots, when the indication information indicates that it is not expected to send the flexible slots or symbols in the time division duplexing (TDD) configuration or frequency band as the uplink slots, the network device may determine that the terminal device does not send data at the slots, when the indication information indicates that it is expected to receive the flexible slots or symbols in the time division duplexing (TDD) configuration or frequency band as the downlink slots, the network device may determine that the terminal device receives data at the slots, and when the indication information indicates that it is not expected to receive the flexible slots or symbols in the time division duplexing (TDD) configuration or frequency band as the downlink slots, the network device may determine that the terminal device does not receive data at the slots.

Alternatively, the terminal device may send the indication information through downlink control information (DCI).

In the disclosure, the expected transmission time information, and the signal transmission feature information and/or frequency information corresponding to the expected transmission time information are sent to the network device by the terminal device, and then the indication information may further be sent to the network device. Thus, the network device may accurately determine, according to the signal transmission feature information and/or frequency information corresponding to the expected transmission time information, a transmission time position expected by the terminal device and perform data transmission at the transmission time position, so that data transmission failure caused by time division interference is avoided, and the communication quality is improved.

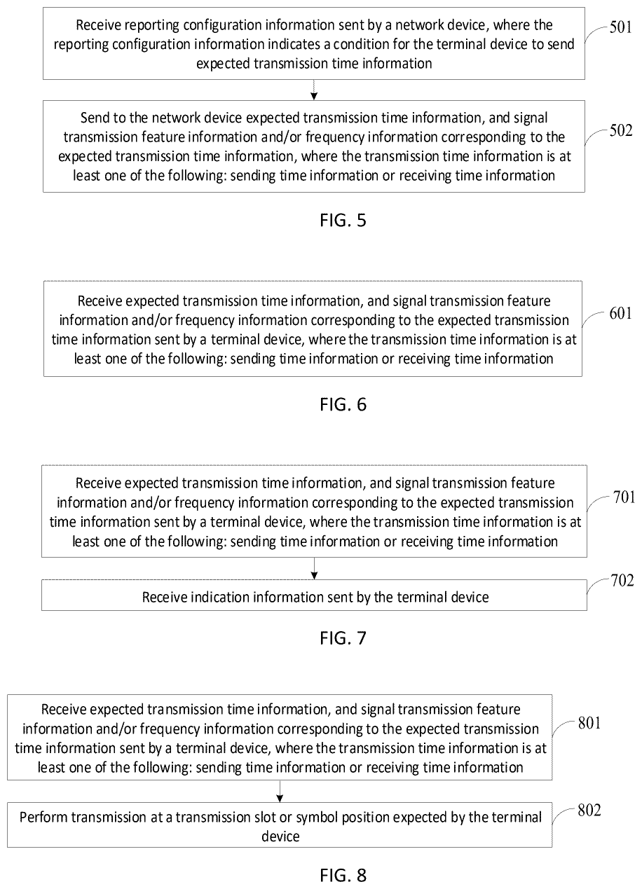

Referring to FIG. 5, FIG. 5 is a schematic flow diagram of a method for canceling time division interference provided by an example of the disclosure. The method is performed by a terminal device. As shown in FIG. 5, the method may include but is not limited to steps 501 and 502.

In step 501, reporting configuration information sent by a network device is received, where the reporting configuration information indicates a condition for the terminal device to send the expected transmission time information.

The reporting configuration information includes at least one of the following: whether to allow to report specific expected transmission time information in a case that a specific expected transmission time information demand exists, a reporting prohibition timer being expired or not running, whether to allow to report a plurality of pieces of expected transmission time information, or whether to allow to report frequency information corresponding to the expected transmission time information.

In the disclosure, the network device may indicate whether the terminal device is allowed to report specific expected transmission time information in a case that a specific expected transmission time information demand exists through any bit in the reporting configuration information, for example, when a value of this bit is 1, the terminal device is allowed to report the specific expected transmission time information in a case that the specific expected transmission time information demand exists, and when a value of this bit is 0, the terminal device is not allowed to report the specific expected transmission time information in a case that the specific expected transmission time information demand exists. The specific expected transmission time information demand may be a scenario demand corresponding to a trigger condition of reporting the expected transmission time information.

Alternatively, when each specific expected transmission time information demand is configured with a corresponding reporting prohibition timer, the network device may indicate that the reporting prohibition timer is expired or does not run, and thus the terminal device cannot report the specific expected transmission time information.

Alternatively, when specific expected transmission time information demands correspond to different expected transmission time information, the terminal device may report a plurality of pieces of expected transmission time information, the network device may indicate whether the terminal device is allowed to report the plurality of pieces of expected transmission time information through any bit in the reporting configuration information, for example, when a value of this bit is 1, the terminal device is allowed to report the plurality of pieces of expected transmission time information, and when a value of this bit is 0, the terminal device is not allowed to report the plurality of pieces of expected transmission time information.

Alternatively, in order to reduce the information amount of the reported expected transmission time information, when a time domain resource allocation granularity corresponding to the expected transmission time information is not determined through the frequency information, the frequency information corresponding to the expected transmission time information may not be reported. The network device may indicate whether the terminal device is allowed to report the frequency information corresponding to the expected transmission time information through any bit in the reporting configuration information, for example, when a value of this bit is 1, the terminal device is allowed to report the frequency information corresponding to the expected transmission time information, and when a value of this bit is 0, the terminal device is not allowed to report the frequency information corresponding to the expected transmission time information.

In step 502, the expected transmission time information, and signal transmission feature information and/or frequency information corresponding to the expected transmission time information are sent to the network device, where the transmission time information is at least one of the following: sending time information or receiving time information.

In the disclosure, see the detailed description of any example of the disclosure for a specific implementation process of step 502, which is not repeated here.

In the disclosure, the terminal device may receive the reporting configuration information which is used to indicate the condition for the terminal device to send the expected transmission time information and sent by the network device, and then the expected transmission time information and the signal transmission feature information and/or frequency information corresponding to the expected transmission time information may be sent to the network device. Thus, the network device may accurately determine, according to the signal transmission feature information and/or frequency information corresponding to the expected transmission time information, a transmission time position expected by the terminal device and perform data transmission at the transmission time position, so that the phenomenon of data transmission failure caused by time division interference is avoided, and the communication quality is improved.

Referring to FIG. 6, FIG. 6 is a schematic flow diagram of a method for canceling time division interference provided by an example of the disclosure. The method is performed by a network device. As shown in FIG. 6, the method may include but is not limited to step 601.

In step 601, expected transmission time information, and signal transmission feature information and/or frequency information corresponding to the expected transmission time information sent by a terminal device are received, where the transmission time information is at least one of the following: sending time information or receiving time information.

An expected transmission time position may be a slot or symbol position where transmission is expected and the like, which is not limited in the disclosure.

Alternatively, the signal transmission feature information corresponding to the expected transmission time information may include at least one of the following: a subcarrier spacing corresponding to the expected transmission time position, such as 15 kHz; or a CP type corresponding to the expected transmission time position, such as a normal CP type and an extended CP type.

Alternatively, the frequency information may be at least one of the following: a cell type indication, a cell group indication, a cell identifier, a bandwidth part (BWP) identifier, a frequency point identifier, a bandwidth, starting frequency information or ending frequency information.

The cell type indication is used to indicate the type of cell. For example, the type of cell indicated by the cell type indication may include: a primary cell (PCell), a secondary cell (SCell), a primary secondary cell (PSCell) or a special cell (SpCell).

The cell group indication is used to indicate the type of cell group. The cell group indicated by the cell group indication may include any one of the following: a master cell group (MCG) or a secondary cell group (SCG).

The cell identifier may be a physical cell identifier (PCI) or a cell global identifier (CGI), etc.

The BWP identifier may be any information which may uniquely determine a BWP, such as a BWP number.

The frequency point identifier may be information which may uniquely determine a frequency point, such as absolute radio frequency channel number (ARFCN) of a center frequency point.

The starting frequency information may be information which may uniquely determine a starting frequency, such as ARFCN of a starting frequency point or a starting physical resource block (PRB) number. The ending frequency information may be information which may uniquely determine an ending frequency, such as ARFCN of an ending frequency point or an ending PRB number.

In a 5G system, in order to increase a frequency band utilization rate, the network device may configure different subcarrier spacings (SCSs) for different cells or BWPs, and thus bandwidths are allocated according to actual communication demands, and bandwidth waste is avoided. Furthermore, different SCSs and CPs may correspond to different time domain resource allocation granularities, for example, subcarrier spacings of 15 kHz and 3015 kHz correspond to different quantities of slots per frame and different quantities of slots per sub-frame, and a normal CP and an extended CP correspond to different quantities of symbols per slot and different quantities of slots per sub-frame. Meanwhile, in the 5G system, uplink and downlink sub-frame configurations may further be performed flexibly according to actual demands, that is, for all slots within a specified cycle, uplink or downlink transmission may be specified to be performed on a specific slot. For example, for 10 slots within a 10 ms cycle, the first 3 slots are downlink slots, the last 3 slots are uplink slots, and the middle 4 slots are flexible slots. Thus, in a more flexible 5G system, in a case that an uplink and downlink slot ratio and a subcarrier spacing are changed continuously, while the expected transmission time information is sent to the network device by the terminal device, it is needed to guarantee that the terminal device and the network device have the consistent understanding on the expected transmission time information reported by the terminal device, then the network device may accurately determine the transmission time position expected by the terminal device and perform data transmission at this transmission time position, and thus the phenomenon of data transmission failure can be avoided, which is beneficial to improving the communication quality.

In the disclosure, while the expected transmission time information is sent to the network device by the terminal device, the signal transmission feature information and/or frequency information corresponding to the expected transmission time information may be sent to the network device, then the network device may determine a corresponding time domain resource allocation granularity according to the signal transmission feature information and/or frequency information corresponding to the expected transmission time information, afterwards, the network device may determine the transmission time position expected by the terminal device, and thus it is guaranteed that the understanding on the expected transmission time information is consistent with the terminal device, and it is further guaranteed that data transmission can be performed at the transmission time position expected by the terminal device.

In the disclosure, the expected transmission time information, and the signal transmission feature information and/or frequency information corresponding to the expected transmission time information sent by the terminal device may be received by the network device. Thus, the network device may accurately determine, according to the signal transmission feature information and/or frequency information corresponding to the expected transmission time information, the transmission time position expected by the terminal device and perform data transmission at the transmission time position, so that the phenomenon of data transmission failure caused by time division interference is avoided, and the communication quality is improved.

Referring to FIG. 7, FIG. 7 is a schematic flow diagram of a method for canceling time division interference provided by an example of the disclosure. The method is performed by a network device. As shown in FIG. 7, the method may include but is not limited to steps 701 and 702.

In step 701, expected transmission time information, and signal transmission feature information and/or frequency information corresponding to the expected transmission time information sent by a terminal device are received, where the transmission time information is at least one of the following: sending time information or receiving time information.

The expected signal transmission feature information may include at least one of the following: a subcarrier spacing corresponding to an expected transmission time position, or a cyclic prefix (CP) type corresponding to the expected transmission time position.

For specific explanation of the signal transmission feature information and/or frequency information corresponding to the expected transmission time information, see the detailed explanation of any example of the disclosure, which is not repeated here.

In the disclosure, an expected transmission time position may include at least one of the following: a slot or symbol position, a slot or symbol position corresponding to a frequency division duplexing (FDD) configuration, a slot or symbol position corresponding to a frequency division duplexing (FDD) frequency band, a slot or symbol position corresponding to an uplink and downlink slot ratio configuration specified in a time division duplexing (TDD) configuration, or a slot or symbol position corresponding to an uplink and downlink slot ratio configuration specified in a time division duplexing (TDD) frequency band.

It is understandable that the slot or symbol position in the expected transmission time position is where transmission is expected. In the disclosure, the expected transmission time position may include at least one of the following: a slot or symbol position where transmission is expected, a slot or symbol position where transmission is expected corresponding to a frequency division duplexing (FDD) configuration, a slot or symbol position where transmission is expected corresponding to a frequency division duplexing (FDD) frequency band, a slot or symbol position where transmission is expected corresponding to an uplink and downlink slot ratio configuration specified in a time division duplexing (TDD) configuration, or a slot or symbol position where transmission is expected corresponding to an uplink and downlink slot ratio configuration specified in a time division duplexing (TDD) frequency band.

Furthermore, the uplink and downlink slot ratio configuration includes at least one of the following: a configuration cycle of an uplink and downlink slot ratio, the quantity of downlink slots in the uplink and downlink slot ratio, the quantity of downlink symbols in the uplink and downlink slot ratio, the quantity of uplink slots in the uplink and downlink slot ratio, the quantity of uplink symbols in the uplink and downlink slot ratio, the quantity of flexible slots in the uplink and downlink slot ratio, or the quantity of flexible symbols in the uplink and downlink slot ratio.

In the disclosure, a slot or symbol position where transmission is expected may be indicated through a bit map. For example, a subcarrier spacing corresponds to 20 slots or symbols, then a bit map containing 20 bits may be used to indicate the slot or symbol position where transmission is expected, where each bit corresponds to 1 uplink (i.e., sending) or downlink (i.e., receiving) slot or symbol, when a value “0” of a bit represents that data transmission at the slot or symbol position is not expected, a value “1” of a bit represents that data transmission at the slot or symbol position is expected, and when a bit is empty, it represents that the slot or symbol position is a flexible slot or symbol.

In the disclosure, the slot or symbol position where transmission is expected corresponding to the frequency division duplexing (FDD) configuration or frequency band may be indicated through a bit map, for example, as for an FDD uplink sending frequency, a subcarrier spacing corresponds to 20 slots or symbols, then a bit map containing 20 bits may be used to indicate a slot or symbol position where sending is expected, where each bit corresponds to 1 uplink (i.e., sending) slot or symbol, and when a value “0” of a bit represents that data sending at the slot or symbol position is not expected, a value “1” of a bit represents that data sending at the slot or symbol position is expected. As for an FDD downlink receiving frequency, a subcarrier spacing corresponds to 20 slots or symbols, then a bit map containing 20 bits may be used to indicate a slot or symbol position where receiving is expected, where each bit corresponds to 1 downlink (i.e., receiving) slot or symbol, when a value “0” of a bit represents that data receiving at the slot or symbol position is not expected, a value “1” of a bit represents that data receiving at the slot or symbol position is expected, and when a bit is empty, it represents that the slot or symbol position is a flexible slot or symbol.

In the disclosure, the slot or symbol position where transmission is expected corresponding to the uplink and downlink slot ratio configuration specified in the time division duplexing (TDD) configuration or frequency band may also be indicated through a bit map. When the uplink and downlink slot ratio configuration includes the configuration cycle of the uplink and downlink slot ratio, the uplink and downlink slot ratio may be periodically repeated, for example, the uplink and downlink slot ratio is repeated with 10 ms as a cycle.

When the uplink and downlink slot ratio configuration includes the quantity of the downlink slots in the uplink and downlink slot ratio, for example, the first 2 slots in 10 slots are downlink slots, slots where transmission is expected corresponding to the downlink slots may be identified using bits with the quantity being the same as the quantity of the downlink slots, when a value “0” of a bit represents that data receiving at the slot position is not expected, a value “1” of a bit represents that data receiving at the slot position is expected, and when a bit is empty, it represents that the slot or symbol position is a flexible slot or symbol.

When the uplink and downlink slot ratio configuration includes the quantity of the downlink symbols in the uplink and downlink slot ratio, for example, the first 2 symbols in 10 symbols are downlink symbols, symbols where transmission is expected corresponding to the downlink symbols may be identified using bits with the quantity being the same as the quantity of the downlink symbols, when a value “0” of a bit represents that data receiving at the symbol position is not expected, a value “1” of a bit represents that data receiving at the symbol position is expected, and when a bit is empty, it represents that the slot or symbol position is a flexible slot or symbol.

When the uplink and downlink slot ratio configuration includes the quantity of the uplink slots in the uplink and downlink slot ratio, for example, the first 2 slots in 10 slots are uplink slots, slots where transmission is expected corresponding to the uplink slots may be identified using bits with the quantity being the same as the quantity of the uplink slots, when a value “0” of a bit represents that data sending at the slot position is not expected, a value “1” of a bit represents that data sending at the slot position is expected, and when a bit is empty, it represents that the slot or symbol position is a flexible slot or symbol.

When the uplink and downlink slot ratio configuration includes the quantity of the uplink symbols in the uplink and downlink slot ratio, for example, the first 2 symbols in 10 symbols are uplink symbols, symbols where transmission is expected corresponding to the uplink symbols may be identified using bits with the quantity being the same as the quantity of the uplink symbols, when a value “0” of a bit represents that data sending at the symbol position is not expected, a value “1” of a bit represents that data sending at the symbol position is expected, and when a bit is empty, it represents that the slot or symbol position is a flexible slot or symbol.

When the uplink and downlink slot ratio configuration includes the quantity of the flexible slots in the uplink and downlink slot ratio, for example, the first 2 slots in 10 slots are flexible slots, slots where transmission is expected corresponding to the flexible slots may be identified using bits with the quantity being the same as the quantity of the flexible slots, and when a value “0” of a bit represents that data sending or receiving at the slot position is not expected, a value “1” of a bit represents that data sending or receiving at the slot position is expected.

When the uplink and downlink slot ratio configuration includes the quantity of the flexible symbols in the uplink and downlink slot ratio, for example, the first 2 symbols in 10 symbols are flexible symbols, symbols where transmission is expected corresponding to the flexible symbols may be identified using bits with the quantity being the same as the quantity of the flexible symbols, and when a value “0” of a bit represents that data sending or receiving at the symbol position is not expected, a value “1” of a bit represents that data sending or receiving at the symbol position is expected.

Alternatively, the expected transmission time information includes a time position where transmission is prohibited. Alternatively, the quantity of time positions where transmission is prohibited in the expected transmission time information is less than or equal to the quantity configured by the network device; or, the quantity of time positions where transmission is prohibited in the expected transmission time information is less than or equal to the quantity agreed in a protocol. The quantity configured by the network device or the quantity agreed in the protocol may be the quantity of uplink hybrid automatic repeat request (HARQ) processes supported by the terminal device or the quantity of downlink HARQ processes supported by the terminal device.

In step 702, indication information sent by the terminal device is received.

The indication information may indicate at least one of the following: whether to expect to send at flexible slots or symbols in the time division duplexing (TDD) configuration or frequency band as uplink slots, whether to expect to receive at the flexible slots or symbols in the time division duplexing (TDD) configuration or frequency band as downlink slots, or whether to expect to use the flexible slots or symbols in the time division duplexing (TDD) configuration or frequency band.

In the disclosure, the terminal device may send indication information to the network device to indicate that the flexible slot or symbol in the time division duplexing (TDD) configuration or frequency band are expected to be uplink slots or symbols, or downlink slots or symbols, or flexible slots or symbols. When the indication information indicates that it is expected to send the flexible slots or symbols in the time division duplexing (TDD) configuration or frequency band as the uplink slots, the network device may determine that the terminal device sends data at the slots, when the indication information indicates that it is not expected to send the flexible slots or symbols in the time division duplexing (TDD) configuration or frequency band as the uplink slots, the network device may determine that the terminal device does not send data at the slots, when the indication information indicates that it is expected to receive the flexible slots or symbols in the time division duplexing (TDD) configuration or frequency band as the downlink slots, the network device may determine that the terminal device receives data at the slots, and when the indication information indicates that it is not expected to receive the flexible slots or symbols in the time division duplexing (TDD) configuration or frequency band as the downlink slots, the network device may determine that the terminal device does not receive data at the slots.

Alternatively, the network device may receive the indication information through downlink control information (DCI).

In the disclosure, the expected transmission time information, and the signal transmission feature information and/or frequency information corresponding to the expected transmission time information sent by the terminal device may be received by the network device, and then the indication information sent by the terminal device may further be received. Thus, the network device may accurately determine, according to the signal transmission feature information and/or frequency information corresponding to the expected transmission time information, the transmission time position expected by the terminal device and perform data transmission at the transmission time position, so that the phenomenon of data transmission failure caused by time division interference is avoided, and the communication quality is improved.

Referring to FIG. 8, FIG. 8 is a schematic flow diagram of a method for canceling time division interference provided by an example of the disclosure. The method is performed by a network device. As shown in FIG. 8, the method may include but is not limited to steps 801 and 802.

In step 801, expected transmission time information, and signal transmission feature information and/or frequency information corresponding to the expected transmission time information sent by a terminal device are received, where the transmission time information is at least one of the following: sending time information or receiving time information.

In the disclosure, see the detailed description of any example of the disclosure for a specific process of step 801, which is not repeated here.

In step 802, transmission is performed at a transmission slot or symbol position expected by the terminal device.

In the disclosure, after the transmission slot or symbol position expected by the terminal device is determined, the network device may perform data transmission at the transmission slot or symbol position expected by the terminal device.

In the disclosure, the expected transmission time information, and the signal transmission feature information and/or frequency information corresponding to the expected transmission time information sent by the terminal device may be received by the network device, and then the network device may perform transmission at the transmission slot or symbol position expected by the terminal device. Thus, the network device may accurately determine, according to the signal transmission feature information and/or frequency information corresponding to the expected transmission time information, a transmission time position expected by the terminal device and perform data transmission at the transmission time position, so that the phenomenon of data transmission failure caused by time division interference is avoided, and the communication quality is improved.

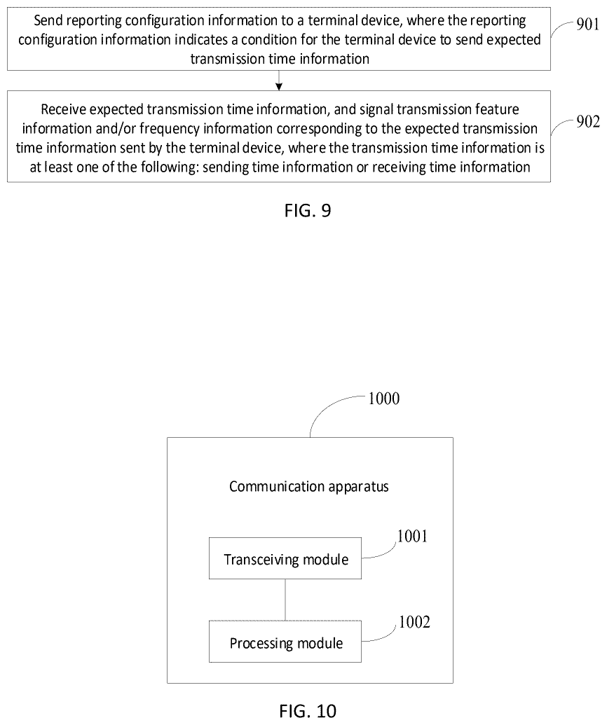

Referring to FIG. 9, FIG. 9 is a schematic flow diagram of a method for canceling time division interference provided by an example of the disclosure. The method is performed by a network device. As shown in FIG. 9, the method may include but is not limited to steps 901 and 902.

In step 901, reporting configuration information is sent to a terminal device, where the reporting configuration information indicates a condition for the terminal device to send expected transmission time information.

The reporting configuration information includes at least one of the following: whether to allow to report specific expected transmission time information in a case that a specific expected transmission time information demand exists, a reporting prohibition timer being expired or not running, whether to allow to report a plurality of pieces of expected transmission time information, or whether to allow to report frequency information corresponding to the expected transmission time information.

In the disclosure, the network device may indicate whether the terminal device is allowed to report specific expected transmission time information in a case that a specific expected transmission time information demand exists through any bit in the reporting configuration information, for example, when a value of this bit is 1, the terminal device is allowed to report the specific expected transmission time information in a case that the specific expected transmission time information demand exists, and when a value of this bit is 0, the terminal device is not allowed to report the specific expected transmission time information in a case that the specific expected transmission time information demand exists. The specific expected transmission time information demand may be a scenario demand corresponding to a trigger condition of reporting the expected transmission time information.

Alternatively, when each specific expected transmission time information demand is configured with a corresponding reporting prohibition timer, the network device may indicate that the reporting prohibition timer is expired or does not run, and thus the terminal device cannot report the specific expected transmission time information.

Alternatively, when specific expected transmission time information demands correspond to different expected transmission time information, the terminal device may report a plurality of pieces of expected transmission time information, the network device may indicate whether the terminal device is allowed to report the plurality of pieces of expected transmission time information through any bit in the reporting configuration information, for example, when a value of this bit is 1, the terminal device is allowed to report the plurality of pieces of expected transmission time information, and when a value of this bit is 0, the terminal device is not allowed to report the plurality of pieces of expected transmission time information.

Alternatively, in order to reduce the information amount of the reported expected transmission time information, when a time domain resource allocation granularity corresponding to the expected transmission time information is not determined through the frequency information, the frequency information corresponding to the expected transmission time information may not be reported. The network device may indicate whether the terminal device is allowed to report the frequency information corresponding to the expected transmission time information through any bit in the reporting configuration information, for example, when a value of this bit is 1, the terminal device is allowed to report the frequency information corresponding to the expected transmission time information, and when a value of this bit is 0, the terminal device is not allowed to report the frequency information corresponding to the expected transmission time information.

In step 902, the expected transmission time information, and signal transmission feature information and/or frequency information corresponding to the expected transmission time information sent by the terminal device are received, where the transmission time information is at least one of the following: sending time information or receiving time information.

In the disclosure, see the detailed description of any example of the disclosure for a specific process of step 902, which is not repeated here.

In the disclosure, the network device may receive the reporting configuration information which is used to indicate the condition for the terminal device to send the expected transmission time information and sent by the terminal device, and then the expected transmission time information and the signal transmission feature information and/or frequency information corresponding to the expected transmission time information sent by the terminal device may be received. Thus, the network device may accurately determine, according to the signal transmission feature information and/or frequency information corresponding to the expected transmission time information, a transmission time position expected by the terminal device and perform data transmission at the transmission time position, so that the phenomenon of data transmission failure caused by time division interference is avoided, and the communication quality is improved.

Referring to FIG. 10, it is a schematic structural diagram of a communication apparatus 1000 provided by an example of the disclosure. The communication apparatus 1000 shown in FIG. 10 may include a processing module 1002 and a transceiving module 1001. The transceiving module 1001 may include a sending module (not shown) and/or a receiving module (not shown), the sending module is configured to achieve a sending function, the receiving module is configured to achieve a receiving function, and the transceiving module 1001 may achieve the sending function and/or the receiving function.

It is to be understood that, the communication apparatus 1000 may be a terminal device or an apparatus in the terminal device, or an apparatus capable of being used in match with the terminal device.

The communication apparatus 1000 is at a terminal device side, where: the transceiving module 1001 is configured to send to a network device expected transmission time information, and signal transmission feature information and/or frequency information corresponding to the expected transmission time information, where the transmission time information is at least one of the following: sending time information or receiving time information.

The communication apparatus 1000 further includes the processing module 1002, which is configured to send to the network device the expected transmission time information in response to determining the satisfaction of a preset trigger condition.

In one non-limiting example, the preset trigger condition is any one of the following: occurring a self-interference problem to the terminal device; having an energy saving demand of the terminal device; and having a capability using limitation demand of the terminal device.

In one non-limiting example, the expected signal transmission feature information includes at least one of the following: a subcarrier spacing corresponding to an expected transmission time position; or a cyclic prefix (CP) type corresponding to the expected transmission time position.

Alternatively, the frequency information is at least one of the following:
a cell type indication, a cell group indication, a cell identifier, a bandwidth part (BWP) identifier, a frequency point identifier, a bandwidth, starting frequency information or ending frequency information.

In one non-limiting example, the expected transmission time position includes at least one of the following: a slot or symbol position where transmission is expected; a slot or symbol position where transmission is expected corresponding to a frequency division duplexing (FDD) configuration; a slot or symbol position where transmission is expected corresponding to a frequency division duplexing (FDD) frequency band; a slot or symbol position where transmission is expected corresponding to an uplink and downlink slot ratio configuration specified in a time division duplexing (TDD) configuration; or a slot or symbol position where transmission is expected corresponding to an uplink and downlink slot ratio configuration specified in a time division duplexing (TDD) frequency band.

In one non-limiting example, the uplink and downlink slot ratio configuration includes at least one of the following: a configuration cycle of an uplink and downlink slot ratio; the quantity of downlink slots in the uplink and downlink slot ratio; the quantity of downlink symbols in the uplink and downlink slot ratio; the quantity of uplink slots in the uplink and downlink slot ratio; the quantity of uplink symbols in the uplink and downlink slot ratio; the quantity of flexible slots in the uplink and downlink slot ratio; or the quantity of flexible symbols in the uplink and downlink slot ratio.

In one non-limiting example, the transceiving module 1001 is further configured to send indication information to the network device. And the indication information indicates at least one of the following: whether to expect to send at a flexible slot or symbol in the time division duplexing (TDD) configuration or frequency band as an uplink slot; whether to expect to receive at the flexible slot or symbol in the time division duplexing (TDD) configuration or frequency band as a downlink slot; or whether to expect to use the flexible slot or symbol in the time division duplexing (TDD) configuration or frequency band.

In one non-limiting example, the quantity of time positions where transmission is prohibited in the expected transmission time information is less than or equal to the quantity configured by the network device; or the quantity of time positions where transmission is prohibited in the expected transmission time information is less than or equal to the quantity agreed in a protocol.

In one non-limiting example, the transceiving module 1001 is further configured to receive reporting configuration information sent by the network device, where the reporting configuration information indicates a condition for the terminal device to send the expected transmission time information.

In one non-limiting example, the reporting configuration information includes at least one of the following: whether to allow to report specific expected transmission time information in a case that a specific expected transmission time information demand exists; a reporting prohibition timer being expired or not running; whether to allow to report a plurality of pieces of expected transmission time information; or whether to allow to report frequency information corresponding to the expected transmission time information.

In the disclosure, the expected transmission time information, and the signal transmission feature information and/or frequency information corresponding to the expected transmission time information are sent to the network device by the terminal device. Thus, the network device may accurately determine, according to the signal transmission feature information and/or frequency information corresponding to the expected transmission time information, the transmission time position expected by the terminal device and perform data transmission at the transmission time position, so that the phenomenon of data transmission failure caused by time division interference is avoided, and the communication quality is improved.

It is to be understood that, the communication apparatus 1000 may be a network device or an apparatus in the network device, or an apparatus capable of being used in match with the network device.

The communication apparatus 1000 is at a network device side, where: the transceiving module 1001 is configured to receive expected transmission time information, and signal transmission feature information and/or frequency information corresponding to the expected transmission time information sent by a terminal device, where the transmission time information is at least one of the following: sending time information or receiving time information.

In one non-limiting example, the expected transmission time information includes at least one of the following: a subcarrier spacing corresponding to an expected transmission time position; or a cyclic prefix (CP) type corresponding to the expected transmission time position.

In one non-limiting example, the frequency information is at least one of the following: a cell type indication, a cell group indication, a cell identifier, a bandwidth part (BWP) identifier, a frequency point identifier, a bandwidth, starting frequency information or ending frequency information.

In one non-limiting example, the expected transmission time position includes at least one of the following: a slot or symbol position where transmission is expected; a slot or symbol position where transmission is expected corresponding to a frequency division duplexing (FDD) configuration; a slot or symbol position where transmission is expected corresponding to a frequency division duplexing (FDD) frequency band; a slot or symbol position where transmission is expected corresponding to an uplink and downlink slot ratio configuration specified in a time division duplexing (TDD) configuration; or a slot or symbol position where transmission is expected corresponding to an uplink and downlink slot ratio configuration specified in a time division duplexing (TDD) frequency band.

In one non-limiting example, the uplink and downlink slot ratio configuration includes at least one of the following: a configuration cycle of an uplink and downlink slot ratio; the quantity of downlink slots in the uplink and downlink slot ratio; the quantity of downlink symbols in the uplink and downlink slot ratio; the quantity of uplink slots in the uplink and downlink slot ratio; the quantity of uplink symbols in the uplink and downlink slot ratio; the quantity of flexible slots in the uplink and downlink slot ratio; or the quantity of flexible symbols in the uplink and downlink slot ratio.

In one non-limiting example, the transceiving module 1001 is further configured to receive indication information sent by the terminal device. And the indication information indicates at least one of the following: whether to expect to send at flexible slots or symbols in the time division duplexing (TDD) configuration or frequency band as uplink slots; whether to expect to receive at the flexible slots or symbols in the time division duplexing (TDD) configuration or frequency band as downlink slots; or whether to expect to use the flexible slots or symbols in the time division duplexing (TDD) configuration or frequency band.

In one non-limiting example, the communication apparatus further includes the processing module 1002, which is configured to perform transmission at a transmission slot or symbol position expected by the terminal device.

In one non-limiting example, the quantity of time positions where transmission is prohibited in the expected transmission time information is less than or equal to the quantity configured by the network device; or the quantity of time positions where transmission is prohibited in the expected transmission time information is less than or equal to the quantity agreed in a protocol.

In one non-limiting example, the transceiving module 1001 is further configured to: send reporting configuration information to the terminal device, where the reporting configuration information indicates a condition for the terminal device to send the expected transmission time information.

In one non-limiting example, the reporting configuration information includes at least one of the following: whether to allow to report specific expected transmission time information in a case that a specific expected transmission time information demand exists; a reporting prohibition timer being expired or not running; whether to allow to report a plurality of pieces of expected transmission time information; or whether to allow to report frequency information corresponding to the expected transmission time information.

In the disclosure, the expected transmission time information, and the signal transmission feature information and/or frequency information corresponding to the expected transmission time information sent by the terminal device may be received by the network device. Thus, the network device may accurately determine, according to the signal transmission feature information and/or frequency information corresponding to the expected transmission time information, the transmission time position expected by the terminal device and perform data transmission at the transmission time position, so that the phenomenon of data transmission failure caused by time division interference is avoided, and the communication quality is improved.

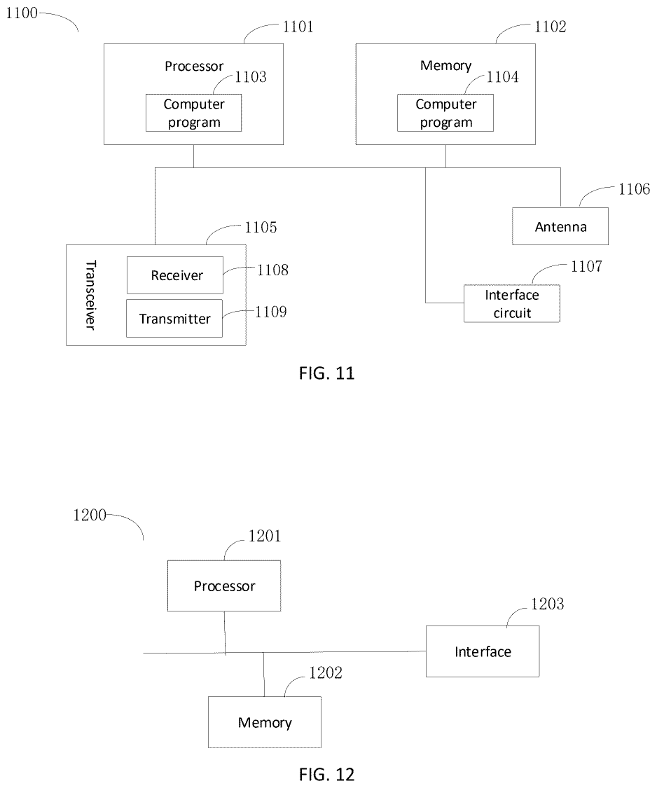

Referring to FIG. 11, FIG. 11 is a schematic structural diagram of another communication apparatus 1100 provided by an example of the disclosure. The communication apparatus 1100 may be a network device, a terminal device, a chip, chip system or processor which support the network device to implement the methods, or a chip, chip system or processor which support the terminal device to implement the methods. The apparatus 1100 may be configured to implement the methods described in the examples, see the descriptions in each of the method examples specifically. As shown, the communication apparatus 1100 includes, but is not limited to, a processor 1101, memory 1102, transceiver 1105, antenna 1106, and interface circuit 1107.

The communication apparatus 1100 may include one or more processors 1101. The processor 1101 may be a general-purpose processor or a special-purpose processor, etc. For example, the processor may be a baseband processor or a central processor. The baseband processor may be configured to process a communication protocol and communication data, and the central processor may be configured to control the communication apparatus (e.g., base station, baseband chip, terminal device, terminal device chip, DU or CU), execute computer programs and process data of computer programs.

The communication apparatus 1100 may further include one or more memories 1102, on which a computer program 1104 may be stored, and the processor 1101 executes the computer program 1104 to cause the communication apparatus 1100 to execute the method described in the above method example. Alternatively, data may further be stored in the memory 1102. The communication apparatus 1100 and the memory 1102 may be arranged independently or integrated.

The communication apparatus 1100 may further include a transceiver 1105 and an antenna 1106. The transceiver 1105 may be called a transceiving unit, a transceiving machine, or a transceiving circuit, etc., and is configured to achieve a transceiving function. The transceiver 1105 may include a receiver 1108 and a transmitter 1109. The receiver 1108 may be called a receiving machine or a receiving circuit, etc., and is configured to achieve a receiving function, and the transmitter 1109 may be called a sender or a sending circuit, etc., and is configured to achieve a sending function.

The communication apparatus 1100 may further include one or more interface circuits 1107. The interface circuit 1107 is configured to receive and transmit code instructions to the processor 1101. The processor 1101 runs the code instructions to cause the communication apparatus 1100 to execute the method described in the above method example.

When the communication apparatus 1100 is the terminal device, the processor 1101 is configured to perform step 301 in FIG. 3 and the like.

When the communication apparatus 1100 is the network device, the transceiver 1105 is configured to perform step 601 in FIG. 6; step 701 and step 702 in FIG. 7; step 801 in FIG. 8; and step 901 and step 902 in FIG. 9.

In an implementation, the processor 1101 may include a transceiver configured to achieve receiving and sending functions. For example, the transceiver may be a transceiving circuit or an interface or an interface circuit. The transceiving circuit, the interface or the interface circuit for achieving the receiving and sending functions may be separated or integrated. These transceiving circuit, interface or interface circuit may be configured to read and write codes/data, or, these transceiving circuit, interface or interface circuit may be configured to transmit or transfer signals.

In an implementation, a computer program 1103 may be stored in the processor 1101, and by running on the processor 1101, the computer program 1103 may cause the communication apparatus 1100 to perform any of the methods described in the method examples. The computer program 1103 may be solidified in the processor 1101, and in this case, the processor 1101 may be implemented by hardware.

In an implementation, the communication apparatus 1100 may include a circuit, and the circuit may achieve the function of sending or receiving or communication in the aforementioned method examples. The processor and the transceiver described in the disclosure may be implemented on an integrated circuit (IC), an analog IC, a radio frequency integrated circuit RFIC, a mixed signal IC, an application specific integrated circuit (ASIC), a printed circuit board (PCB), an electronic device, etc. The processor and the transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium(SiGe) and gallium arsenide (GaAs).

The communication apparatus 1100 described in the example may be the network device or the terminal device, but the scope of the communication apparatus described in the disclosure is not limited to this, and the structure of the communication apparatus may not be limited by FIG. 11. The communication apparatus may be an independent device or a part of a large device. For example, the communication apparatus may be: (1) an independent integrated circuit IC, or a chip or a chip system or a sub-system; (2) a collection with one or more ICs, where alternatively, the IC collection may also include a storage component for storing data and computer programs; (3) an ASIC, such as a modem; (4) a module capable of being embedded into other devices; (5) a receiver, a terminal device, a smart terminal device, a cellular phone, a wireless device, a handset, a mobile unit, a vehicle-mounted device, a network device, a cloud device, an artificial intelligence device, etc.; and (6) others.

For the case that the communication apparatus may be a chip or a chip system, see a schematic structural diagram of a chip 1200 shown in FIG. 12. The chip 1200 shown in FIG. 12 includes a processor 1201, a memory 1202, and an interface 1203. There may be one or more processors 1201, one or more memories 1202, and a plurality of interfaces 1203.

For the case that the chip 1200 is configured to achieve functions of a terminal device in an example of the disclosure, the interface 1203 is configured to perform step 201 in FIG. 2; step 401 and step 402 in FIG. 4; and step 501 and step 502 in FIG. 5, and the like.

For the case that the chip 1200 is configured to achieve functions of a network device in an example of the disclosure, the interface 1203 is configured to perform step 601 in FIG. 6; step 701 and step 702 in FIG. 7; step 801 in FIG. 8; and step 901 and step 902 in FIG. 9, and the like.

The memory 1202 is configured to store necessary computer programs and data.

Those skilled in the art may further understand that various illustrative logic blocks and steps listed in the example of the disclosure may be implemented through electronic hardware, computer software or a combination of the two. Whether such functions are achieved through hardware or software depends on specific applications and the design requirements of an entire system. Those skilled in the art may use various methods to achieve the functions for each specific application, but such implementation should not be considered to be beyond the scope of protection of the example of the disclosure.

The disclosure further provides a non-transitory readable storage medium, on which instructions are stored, and when executed by a computer, the instructions achieve the function of any method example.

The disclosure further provides a computer program product, and when executed by a computer, the computer program product achieves the function of any method example.

The examples may be implemented entirely or partially through software, hardware, firmware or any combination of them. When software is used for implementation, implementation may be entirely or partially performed in the form of the computer program product. The computer program product includes one or more computer programs. When the computer program is loaded and executed on a computer, all or part of the flows or functions described according to the examples of the disclosure are generated. The computer may be a general-purpose computer, a special-purpose computer, a computer network, or other programmable apparatuses. The computer program may be stored in a non-transitory computer-readable storage medium or transmitted from one non-transitory computer-readable storage medium to another non-transitory computer-readable storage medium. For example, the computer program may be transmitted from one website, computer, server or data center to another website, computer, server or data center in a wired (for example, a coaxial cable, an optical fiber or a digital subscriber line (DSL)) or wireless (for example, infrared, wireless or microwave) manner. The non-transitory computer-readable storage medium may be any available medium capable of being accessed by a computer or include one or more data storage devices integrated by an available medium, such as a server and a data center. The available medium may be a magnetic medium (such as a floppy disk, a hard disk, or magnetic tape), an optical medium (such as a high-density digital video disc (DVD)), or a semiconductor medium (such as a solid state disk (SSD)) or the like.

Those of ordinary skill in the art may understand that: various numerical numbers involved in the disclosure, such as first and second, are distinguished only for the convenience of description and are not intended to limit the scope of the examples of the disclosure, but also indicate an order of priority.

At least one in the disclosure may also be described as one or more, and “a plurality of” may be two, three, four, or more, without limitation in the disclosure. In the examples of the disclosure, for a technical feature, technical features in the technical feature are distinguished by “first”, “second”, “third”, “A”, “B”, “C”, and “D”, etc., and the technical features described by “first”, “second”, “third”, “A”, “B”, “C”, and “D” have no order of priority or size.

Correspondence relationships shown in each table in the disclosure may be configured or predefined. Values of information in each table are only examples and may be configured as other values, which are not limited in the disclosure. When the correspondence relationships between information and various parameters are configured, it is not necessarily required to configure all the correspondence relationships shown in each table. For example, in the tables in the disclosure, the correspondence relationships shown in certain rows may not be configured. For another example, appropriate transformation adjustments may be made based on the above tables, such as splitting and merging. The names of parameters shown in titles in the above tables may also be other names that a communication apparatus can understand, and values or representations of the parameters may also be other values or representations that the communication apparatus can understand. The above tables may also be implemented using other data structures, such as arrays, queues, containers, stacks, linear tables, pointers, linked lists, trees, graphs, structures, classes, heaps, hashed lists or hash tables, etc.

Pre-definitions in the disclosure may be understood as definitions, advanced definitions, storage, pre-storage, pre-negotiation, pre-configurations, solidification, or pre-firing.

A person of ordinary skill in the art may recognize that the exemplary units and algorithm steps described with reference to the examples disclosed here can be implemented by electronic hardware, or a combination of computer software and electronic hardware. Whether the functions are executed in a mode of hardware or software depends on particular applications and design constraint conditions of the technical solutions. A person skilled in the art may use different methods to implement the described functions for each particular application, but it shall not be considered that the implementation goes beyond the scope of the disclosure.

Those skilled in the art may clearly understand that, for the convenience and conciseness of description, specific working processes of the systems, apparatuses and units described may refer to the corresponding processes in the aforementioned method example, and will not be repeated here.

The described is only the detailed implementations of the disclosure, but the scope of protection of the disclosure is not limited to this. Any change or replacement that can be easily obtained by a person skilled in the art within the technical scope disclosed in the disclosure should be covered in the scope of protection of the disclosure. Thus, the scope of protection of the disclosure shall be subject to the scope of protection of the claims.

1. A method for canceling time division interference, performed by a terminal device, comprising:
sending to a network device expected transmission time information, and at least one of signal transmission feature information or frequency information corresponding to the expected transmission time information, and
wherein the expected transmission time information is at least one of the following: sending time information or receiving time information.

2. The method according to claim 1, wherein sending to the network device the expected transmission time information comprises:
sending to the network device the expected transmission time information in response to determining a satisfaction of a preset trigger condition.

3. The method according to claim 2, wherein the preset trigger condition is any one of the following:
occurring a self-interference problem to the terminal device;
having an energy saving demand of the terminal device; or
having a capability using limitation demand of the terminal device.

4. The method according to claim 1, wherein the signal transmission feature information corresponding to the expected transmission time information comprises at least one of the following:
a subcarrier spacing corresponding to an expected transmission time position; or
a cyclic prefix (CP) type corresponding to the expected transmission time position.

5. The method according to claim 4, wherein the frequency information is at least one of the following:
a cell type indication, a cell group indication, a cell identifier, a bandwidth part (BWP) identifier, a frequency point identifier, a bandwidth, starting frequency information or ending frequency information.

6. The method according to claim 4, wherein the expected transmission time position comprises at least one of the following:
a slot or symbol position;
a slot or symbol position corresponding to a frequency division duplexing (FDD) configuration;
a slot or symbol position corresponding to a frequency division duplexing (FDD) frequency band;
a slot or symbol position corresponding to an uplink and downlink slot ratio configuration specified in a time division duplexing (TDD) configuration; or
a slot or symbol position corresponding to an uplink and downlink slot ratio configuration specified in a time division duplexing (TDD) frequency band.

7. The method according to claim 6, wherein the uplink and downlink slot ratio configuration comprises at least one of the following:
a configuration cycle of an uplink and downlink slot ratio;
a quantity of downlink slots in the uplink and downlink slot ratio;
the quantity of downlink symbols in the uplink and downlink slot ratio;
the quantity of uplink slots in the uplink and downlink slot ratio;
the quantity of uplink symbols in the uplink and downlink slot ratio;
the quantity of flexible slots in the uplink and downlink slot ratio; or
the quantity of flexible symbols in the uplink and downlink slot ratio.

8. The method according to claim 6, further comprising:
sending indication information to the network device, wherein the indication information indicates at least one of the following:
whether to expect to send at a flexible slot or symbol in the TDD configuration or frequency band;
whether to expect to receive at the flexible slot or symbol in the TDD configuration or frequency band; or
whether to expect to use the flexible slot or symbol in TDD configuration or frequency band.

9. The method according to claim 1, wherein the expected transmission time information comprises a time position where transmission is prohibited, and wherein
a quantity of time positions where transmission is prohibited is less than or equal to the quantity configured by the network device; or
a quantity of time positions where transmission is prohibited is less than or equal to the quantity agreed in a protocol.

10. The method according to claim 1, further comprising:
receiving reporting configuration information sent by the network device, wherein the reporting configuration information indicates a condition for the terminal device to send the expected transmission time information.

11. The method according to claim 10, wherein the reporting configuration information comprises at least one of the following:
whether to allow to report specific expected transmission time information in a case that a specific expected transmission time information demand exists;
a reporting prohibition timer being expired or not running;
whether to allow to report a plurality of pieces of expected transmission time information; or
whether to allow to report frequency information corresponding to the expected transmission time information.

12. A method for canceling time division interference, performed by a network device, comprising:
receiving expected transmission time information, and at least one of signal transmission feature information or frequency information corresponding to the expected transmission time information sent by a terminal device, and
wherein the expected transmission time information is at least one of the following: sending time information or receiving time information.

13. The method according to claim 12, wherein the expected transmission time information comprises at least one of the following:
a subcarrier spacing corresponding to an expected transmission time position; or
a cyclic prefix (CP) type corresponding to the expected transmission time position.

14. (canceled)

15. The method according to claim 13, wherein the expected transmission time position comprises at least one of the following:
a slot or symbol position;
a slot or symbol position corresponding to a frequency division duplexing (FDD) configuration;
a slot or symbol position corresponding to a frequency division duplexing (FDD) frequency band;
a slot or symbol position corresponding to an uplink and downlink slot ratio configuration specified in a time division duplexing (TDD) configuration; or
a slot or symbol position corresponding to an uplink and downlink slot ratio configuration specified in a time division duplexing (TDD) frequency band.

16. The method according to claim 15, wherein the uplink and downlink slot ratio configuration comprises at least one of the following:
a configuration cycle of an uplink and downlink slot ratio;
a quantity of downlink slots in the uplink and downlink slot ratio;
the quantity of downlink symbols in the uplink and downlink slot ratio;
the quantity of uplink slots in the uplink and downlink slot ratio;
the quantity of uplink symbols in the uplink and downlink slot ratio;
the quantity of flexible slots in the uplink and downlink slot ratio; or
the quantity of flexible symbols in the uplink and downlink slot ratio.

17. The method according to claim 15, further comprising: receiving indication information sent by the terminal device, wherein the indication information indicates at least one of the following:
whether to expect to send at a flexible slot or symbol in the TDD configuration or frequency band;
whether to expect to receive at the flexible slot or symbol in the TDD configuration or frequency band; or
whether to expect to use the flexible slot or symbol in the TDD configuration or frequency band.

18. The method according to claim 15, further comprising:
performing transmission at a transmission slot or symbol position expected by the terminal device.

19. The method according to claim 12, wherein the expected transmission time information comprises a time position where transmission is prohibited, and wherein
a quantity of time positions where transmission is prohibited is less than or equal to the quantity configured by the network device; or
a quantity of time positions where transmission is prohibited is less than or equal to the quantity agreed in a protocol.

20. The method according to claim 12, further comprising:
sending reporting configuration information to the terminal device, wherein the reporting configuration information indicates a condition for the terminal device to send the expected transmission time information.

21.-23. (canceled)

24. A communication apparatus, comprising one or more processors and one or more memories, wherein the one or more memories store a computer program, and the one or more processors execute the computer program stored in the one or more memories to cause the communication apparatus to perform:
sending to a network device expected transmission time information, and at least one of signal transmission feature information or frequency information corresponding to the expected transmission time information, and
wherein the transmission time information is at least one of the following: sending time information or receiving time information.

25. (canceled)
